(19) United States
(12) Patent Application Publication
(10) Pub. No.: US 2023/0176208 A1
(43) Pub. Date: Jun. 8, 2023

(54) ROAD SHAPE ESTIMATION DEVICE, ROAD SHAPE ESTIMATION METHOD, AND COMPUTER-READABLE MEDIUM

(71) Applicant: Mitsubishi Electric Corporation, Tokyo (JP)

(72) Inventors: Tetsuro FURUTA, Tokyo (JP); Hiroshi SAKAMAKI, Tokyo (JP); Kei SUWA, Tokyo (JP)

(73) Assignee: Mitsubishi Electric Corporation, Tokyo (JP)

(21) Appl. No.: 18/008,780

(22) PCT Filed: Jun. 12, 2020
(86) PCT No.: PCT/JP2020/023127

§ 371 Date: Dec. 7, 2022

(51) Int. Cl. G01S 13/89; G01S 7/41; G06T 7/64

(52) U.S. Cl. CPC G01S 13/89; G01S 7/41; G06T 7/64; G06T 2207/10044; G06T 2207/30256

(57) ABSTRACT

A road shape estimation device includes processing circuitry to detect, from received signals of radio waves reflected by an object present around a vehicle, reflection points each indicating a reflection position of each radio wave on the object, to perform classification of reflection points of an object present in a left side area of the vehicle into a first group, and of reflection points of an object present in a right side area of the vehicle into a second group, to perform translation of each reflection point classified into the first group to a right direction of the vehicle, and perform translation of each reflection point classified into the second group to a left direction of the vehicle, and to calculate an approximate curve representing a point cloud including all reflection points after the translation and perform estimation of a shape of the road from the approximate curve.

### TECHNICAL FIELD

The present disclosure relates to a road shape estimation device, a road shape estimation method, and a road shape estimation program for estimating a shape of a road.

### BACKGROUND ART

Patent Literature 1 listed below discloses a road shape estimation device including object detection means and estimation means.

The object detection means repeatedly detects one of a reflection point of a radio wave on an object present near the left edge of a road (hereinafter referred to as a “left side reflection point”) and a reflection point of a radio wave on an object present near the right edge of the road (hereinafter referred to as a “right side reflection point”). The estimation means estimates the shape of the road on the basis of either the shape of a point cloud including a plurality of left side reflection points detected by the object detection means or the shape of a point cloud including a plurality of right side reflection points detected by the object detection means.

### CITATION LIST

### Patent Literature

Patent Literature 1: JP 2010-107447 A

### SUMMARY OF INVENTION

### Technical Problem

The road shape estimation device disclosed in Patent Literature 1 has a problem that the estimation means may not be able to estimate the shape of the road because the number of left side reflection points detected by the object detection means or the number of right side reflection points detected by the object detection means is small. The shape of a curved road cannot be estimated unless three or more points of either the left side reflection point or the right side reflection point are detected.

The present disclosure has been made to solve the above problems, and an object of the present disclosure is to obtain a road shape estimation device, a road shape estimation method, and a road shape estimation program capable of estimating a shape of a road in some cases even when the number of left side reflection points or the number of right side reflection points is small.

### Solution to Problem

A road shape estimation device according to the present disclosure includes: a reflection point detecting unit detecting, from received signals of a plurality of radio waves reflected by an object present around a vehicle, a plurality of reflection points each indicating a reflection position of each of the radio waves on the object; a reflection point classifying unit classifying, among the plurality of reflection points detected by the reflection point detecting unit, reflection points of an object present in an area on a left side with respect to a traveling direction of the vehicle into a first group, and classifying, among the plurality of reflection points, reflection points of an object present in an area on a right side with respect to the traveling direction of the vehicle into a second group; a translation unit performing translation of each of the reflection points classified into the first group by the reflection point classifying unit to a right direction of the vehicle orthogonal to the traveling direction of the vehicle, and performing translation of each of the reflection points classified into the second group by the reflection point classifying unit to a left direction of the vehicle orthogonal to the traveling direction of the vehicle; and a road shape estimating unit calculating an approximate curve representing a point cloud including all of the plurality of reflection points after the translation performed by the translation unit and estimating a shape of a road on which the vehicle travels from the approximate curve.

### Advantageous Effects of Invention

According to the present disclosure, even when the number of left side reflection points or the number of right side reflection points is small, the shape of the road can be estimated in some cases.

### BRIEF DESCRIPTION OF DRAWINGS

FIG. 1 is a configuration diagram illustrating a road shape estimation device 10 according to a first embodiment.

FIG. 2 is a hardware configuration diagram illustrating hardware of the road shape estimation device 10 according to the first embodiment.

FIG. 3 is a hardware configuration diagram of a computer in a case where the road shape estimation device 10 is implemented by software, firmware, or the like.

FIG. 4 is a flowchart illustrating a road shape estimation method which is a processing procedure performed by the road shape estimation device 10 according to the first embodiment.

FIG. 5 is an explanatory diagram illustrating an azimuth of an object.

FIG. 6 is an explanatory diagram illustrating an object 53 present in an area on the left side with respect to a traveling direction of a vehicle and an object 54 present in an area on the right side with respect to the traveling direction of the vehicle.

FIG. 7 is an explanatory diagram illustrating a plurality of divided areas.

FIG. 8 is an explanatory diagram illustrating an example in which a plurality of divided areas including a reflection point refₘ are classified into six groups (G1) to (G6).

FIG. 9 is an explanatory diagram illustrating a reflection point refᵢ and a reflection point refⱼ, and a first approximate curve y₁(x) and a second approximate curve y₂(x).

FIG. 10 is an explanatory diagram illustrating a reflection point refᵢ after translation and a reflection point refⱼ after translation, and an approximate curve representing a point cloud including all the reflection points refᵢ and refⱼ after translation.

FIG. 11 is an explanatory diagram illustrating a third approximate curve y₃(x) and a fourth approximate curve y₄(x).

FIG. 12 is an explanatory diagram for describing processing of determining whether or not an object is present in a road.

FIG. 13 is an explanatory diagram illustrating original reflection points refᵢ and refⱼ and virtual reflection points refᵢ and refⱼ.

FIG. 14 is an explanatory diagram illustrating an approximate curve y_{Trans}(x) representing a point cloud including all reflection points refᵢ and refⱼ after translation by a translation unit 19.

FIG. 15 is an explanatory diagram illustrating divided areas included in each of a first group and a second group, and a first approximate curve y₁(x) and a second approximate curve y₂(x).

FIG. 16 is an explanatory diagram illustrating divided areas including reflection points refᵤ and refᵥ after translation and an approximate curve representing a point cloud including all the reflection points refᵤ and refᵥ after translation.

FIG. 17 is an explanatory diagram illustrating a third approximate curve y₃(x) and a fourth approximate curve y₄(x).

FIG. 18 is an explanatory diagram illustrating a reflection point refᵢ and a reflection point refⱼ, and a first approximate curve y₁(x) and a second approximate curve y₂(x).

FIG. 19 is an explanatory diagram illustrating a reflection point refᵢ after translation and a reflection point refⱼ after translation, and an approximate curve representing a point cloud including all the reflection points refᵢ and refⱼ after translation.

FIG. 20 is an explanatory diagram illustrating a third approximate curve y₃(x) and a fourth approximate curve y₄(x).

FIG. 21 is a configuration diagram illustrating a road shape estimation device 10 according to a third embodiment.

FIG. 22 is a hardware configuration diagram illustrating hardware of the road shape estimation device 10 according to the third embodiment.

### DESCRIPTION OF EMBODIMENTS

In order to explain the present disclosure in more detail, some embodiments for carrying out the present disclosure will be described below with reference to the accompanying drawings.

### First Embodiment

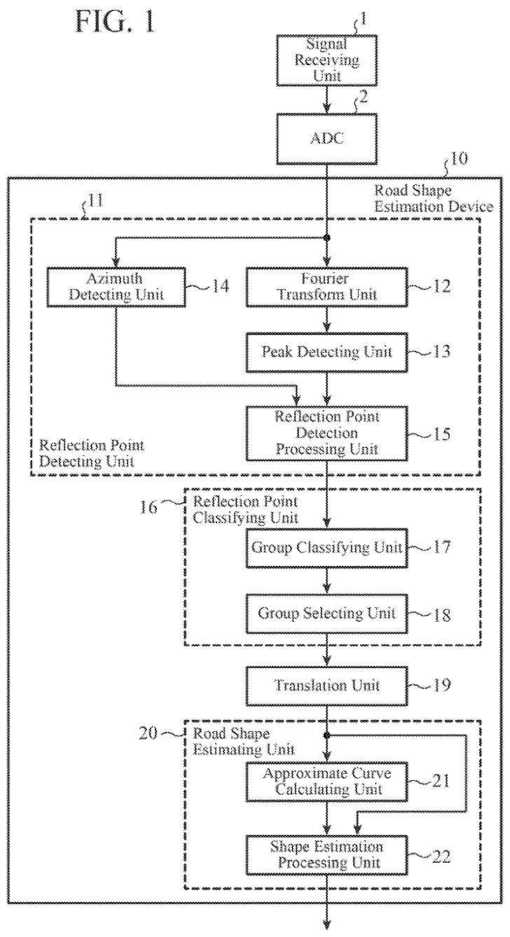

FIG. 1 is a configuration diagram illustrating a road shape estimation device 10 according to a first embodiment.

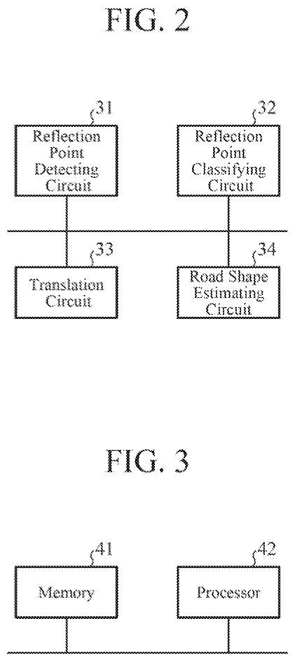

FIG. 2 is a hardware configuration diagram illustrating hardware of the road shape estimation device 10 according to the first embodiment.

In FIG. 1, a signal receiving unit 1 is included in, for example, a radar device disposed in a vehicle.

The radar device includes, for example, a transmitter, a transmitting antenna, a receiving antenna, and the signal receiving unit 1.

The signal receiving unit 1 receives a plurality of radio waves reflected by objects object present around the vehicle.

The signal receiving unit 1 outputs a received signal of each of the radio waves to an analog to digital converter (ADC) 2.

The ADC 2 converts the respective received signals output from the signal receiving unit 1 from analog signals to digital signals, and outputs the respective digital signals to the road shape estimation device 10.

The road shape estimation device 10 includes a reflection point detecting unit 11, a reflection point classifying unit 16, a translation unit 19, and a road shape estimating unit 20.

The reflection point detecting unit 11 is implemented by, for example, a reflection point detecting circuit 31 illustrated in FIG. 2.

The reflection point detecting unit 11 includes a Fourier transform unit 12, a peak detecting unit 13, an azimuth detecting unit 14, and a reflection point detection processing unit 15.

The reflection point detecting unit 11 detects a reflection point indicating a reflection position of each of the radio waves on the object from each of the digital signals output from the ADC 2.

The reflection point detecting unit 11 outputs each of the detected reflection points to the reflection point classifying unit 16.

The Fourier transform unit 12 generates an FR map in which the horizontal axis is the frequency F and the vertical axis is the range R by performing Fourier transform on each of the digital signals output from the ADC 2 in a range direction and a hit direction. The FR map indicates a Fourier transform result of each of a plurality of digital signals, and indicates a relative distance between the vehicle in which the signal receiving unit 1 is disposed and the object, a relative speed between the vehicle and the object, and a signal strength level.

The peak detecting unit 13 performs, for example, constant false alarm rate (CFAR) processing to detect a signal strength level larger than a threshold among a plurality of signal strength levels indicated in the FR map. The threshold is, for example, a value based on a false alarm probability of falsely detecting noise or ground clutter as an object present around the vehicle.

The peak detecting unit 13 detects peak positions indicating positions of signal strength levels higher than the threshold in the FR map. The signal strength level at the peak position represents the signal strength level of the reflection point.

The peak detecting unit 13 outputs each of the detected peak positions to the reflection point detection processing unit 15.

The azimuth detecting unit 14 detects an azimuth of each object from each of the digital signals output from the ADC 2 using an arrival direction estimation method such as a multiple signal classification (MUSIC) method or an estimation of signal parameters via rotational invariance techniques (ESPRIT) method.

The reflection point detection processing unit 15 acquires a relative distance corresponding to each of the peak positions detected by the peak detecting unit 13 from the FR map generated by the Fourier transform unit 12.

The reflection point detection processing unit 15 detects each of the reflection points from the relative distance corresponding to each of the peak positions and the azimuth of each object detected by the azimuth detecting unit 14.

The reflection point detection processing unit 15 outputs each of the detected reflection points to a group classifying unit 17.

The reflection point classifying unit 16 is implemented by, for example, a reflection point classifying circuit 32 illustrated in FIG. 2.

The reflection point classifying unit 16 includes a group classifying unit 17 and a group selecting unit 18.

The reflection point classifying unit 16 classifies reflection points of an object present in the area on the left side with respect to the traveling direction of the vehicle among the reflection points detected by the reflection point detecting unit 11 into a first group.

The reflection point classifying unit 16 classifies reflection points of an object present in the area on the right side with respect to the traveling direction of the vehicle among the reflection points detected by the reflection point detecting unit 11 into a second group.

In the road shape estimation device 10 illustrated in FIG. 1, the area around the vehicle is divided into a plurality of divided areas.

The group classifying unit 17 specifies a divided area including each of the reflection points detected by the reflection point detection processing unit 15.

The group classifying unit 17 specifies, among a plurality of the specified divided areas, a group including a set of divided areas, each of the divided areas being in contact with another divided area including a reflection point and a group including only one divided area not in contact with another divided area including a reflection point.

The group classifying unit 17 classifies each of the specified groups into a left group present in an area on the left side with respect to the traveling direction of the vehicle or a right group present in an area on the right side with respect to the traveling direction of the vehicle.

The group selecting unit 18 selects, among one or more groups classified into the left group by the group classifying unit 17, a group including the largest number of divided areas as the first group.

The group selecting unit 18 selects, among one or more groups classified into the right group by the group classifying unit 17, a group including the largest number of divided areas as the second group.

The translation unit 19 is implemented by, for example, a translation circuit 33 illustrated in FIG. 2.

The translation unit 19 translates each of the reflection points classified into the first group by the reflection point classifying unit 16 to the right direction of the vehicle orthogonal to the traveling direction of the vehicle.

That is, the translation unit 19 calculates a first approximate curve representing a point cloud including all the reflection points classified into the first group by the reflection point classifying unit 16, and translates each of the reflection points classified into the first group to the right direction of the vehicle by a value of a constant term corresponding to the first approximate curve.

Assuming that the road surface on which the vehicle travels is a flat surface, the right direction of the vehicle is a direction substantially parallel to the flat surface.

The translation unit 19 translates each of the reflection points classified into the second group by the reflection point classifying unit 16 to the left direction of the vehicle orthogonal to the traveling direction of the vehicle.

That is, the translation unit 19 calculates a second approximate curve representing a point cloud including all the reflection points classified into the second group by the reflection point classifying unit 16, and translates each of the reflection points classified into the second group by a value of a constant term corresponding to the second approximate curve to the left direction of the vehicle.

The left direction of the vehicle is a direction substantially parallel to the flat surface.

The orthogonality here is not limited to one strictly orthogonal to the traveling direction of the vehicle, and is a concept including one deviated from the orthogonality as long as there is no practical problem.

In addition, the translation here is not limited to strict translation, and is a concept including substantially parallel movement as long as there is no practical problem.

The road shape estimating unit 20 is implemented by, for example, a road shape estimating circuit 34 illustrated in FIG. 2.

The road shape estimating unit 20 includes an approximate curve calculating unit 21 and a shape estimation processing unit 22.

The road shape estimating unit 20 calculates an approximate curve representing a point cloud including all reflection points after translation by the translation unit 19, and estimates the shape of the road on which the vehicle travels from the approximate curve.

The road shape estimating unit 20 outputs the estimation result of the road shape to, for example, a navigation device mounted on the vehicle or a control device of the vehicle.

The approximate curve calculating unit 21 calculates an approximate curve representing a point cloud including all the reflection points after translation by the translation unit 19.

The shape estimation processing unit 22 calculates a third approximate curve represented by the curvature of the approximate curve calculated by the approximate curve calculating unit 21 and the constant term corresponding to the first approximate curve calculated by the translation unit 19.

The shape estimation processing unit 22 calculates a fourth approximate curve represented by the curvature of the approximate curve calculated by the approximate curve calculating unit 21 and the constant term corresponding to the second approximate curve calculated by the translation unit 19.

The shape estimation processing unit 22 estimates the shape of the road on which the vehicle travels from the third approximate curve and the fourth approximate curve.

In FIG. 1, it is assumed that each of the reflection point detecting unit 11, the reflection point classifying unit 16, the translation unit 19, and the road shape estimating unit 20, which are components of the road shape estimation device 10, is implemented by dedicated hardware as illustrated in FIG. 2. That is, it is assumed that the road shape estimation device 10 is implemented by the reflection point detecting circuit 31, the reflection point classifying circuit 32, the translation circuit 33, and the road shape estimating circuit 34.

Each of the reflection point detecting circuit 31, the reflection point classifying circuit 32, the translation circuit 33, and the road shape estimating circuit 34 corresponds to, for example, a single circuit, a composite circuit, a programmed processor, a parallel-programmed processor, an application specific integrated circuit (ASIC), a field-programmable gate array (FPGA), or a combination thereof.

The components of the road shape estimation device 10 are not limited to those implemented by dedicated hardware, and the road shape estimation device 10 may be implemented by software, firmware, or a combination of software and firmware.

The software or firmware is stored in a memory of a computer as a program. The computer means hardware that executes a program, and corresponds to, for example, a central processing unit (CPU), a central processor, a processing unit, an arithmetic unit, a microprocessor, a microcomputer, a processor, or a digital signal processor (DSP).

FIG. 3 is a hardware configuration diagram of a computer in a case where the road shape estimation device 10 is implemented by software, firmware, or the like.

When the road shape estimation device 10 is implemented by software, firmware, or the like, a road shape estimation program for causing a computer to execute a processing procedure performed in each of the reflection point detecting unit 11, the reflection point classifying unit 16, the translation unit 19, and the road shape estimating unit 20 is stored in a memory 41. Then, a processor 42 of the computer executes the road shape estimation program stored in the memory 41.

In addition, FIG. 2 illustrates an example in which each of the components of the road shape estimation device 10 is implemented by dedicated hardware, and FIG. 3 illustrates an example in which the road shape estimation device 10 is implemented by software, firmware, or the like. However, this is merely an example, and some components in the road shape estimation device 10 may be implemented by dedicated hardware, and the remaining components may be implemented by software, firmware, or the like.

Next, the operation of the road shape estimation device 10 illustrated in FIG. 1 will be described.

A radio wave is radiated from a transmitting antenna of a radar device (not illustrated) disposed in a vehicle.

The radio wave radiated from the transmitting antenna is reflected by an object present around the vehicle. Examples of the object present around the vehicle include a guardrail, an outer wall of a building, a road sign, a postbox, and a street tree.

The signal receiving unit 1 receives a plurality of radio waves reflected by objects present around the vehicle.

In the road shape estimation device 10 illustrated in FIG. 1, it is assumed that the signal receiving unit 1 receives M radio waves. M represents an integer of 3 or more. The M radio waves may be radio waves reflected by different objects or may be radio waves reflected by different portions of one object.

The signal receiving unit 1 outputs received signals rₘ of the M radio waves to the ADC 2. Here, m=1, 2, . . . , M.

Upon receiving each of the received signals rₘ from the signal receiving unit 1, the ADC 2 converts each of the received signals rₘ from analog signals to digital signals dₘ, and outputs each of the digital signals dₘ to the road shape estimation device 10.

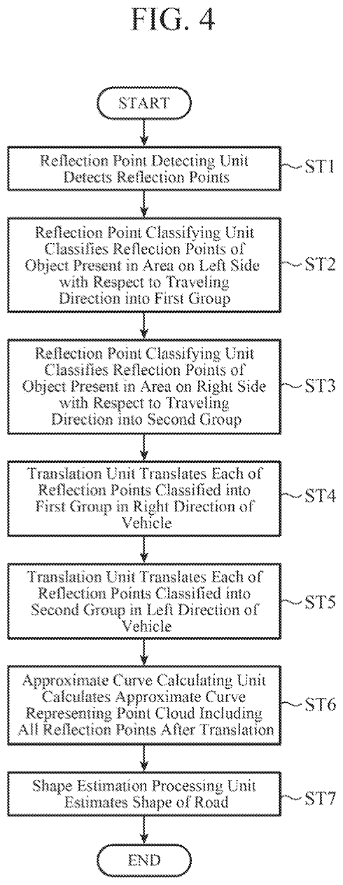

FIG. 4 is a flowchart illustrating a road shape estimation method which is a processing procedure performed by the road shape estimation device 10 according to the first embodiment.

Upon receiving each of the digital signals dₘ from the ADC 2, the reflection point detecting unit 11 detects a reflection point refₘ indicating a reflection position of each of the radio waves on the object from each of the digital signals dₘ (step ST1 in FIG. 4).

The reflection point detecting unit 11 outputs each of the detected reflection points refₘ to the reflection point classifying unit 16.

Hereinafter, the detection processing of the reflection point refₘ by the reflection point detecting unit 11 will be specifically described.

Upon receiving each of the digital signals dₘ from the ADC 2, the Fourier transform unit 12 generates the FR map by performing Fourier transform on each of the digital signals dₘ in the range direction and the hit direction. The FR map indicates a Fourier transform result of each of the digital signals d₁ to dₘ.

The peak detecting unit 13 detects a signal strength level Lₘ larger than a threshold Th among a plurality of signal strength levels indicated in the FR map by performing, for example, CFAR processing.

Then, the peak detecting unit 13 detects a peak position pₘ indicating the position of the signal strength level Lₘ larger than the threshold Th in the FR map. The signal strength level Lₘ at the peak position pₘ represents the signal strength level of the reflection point refₘ.

The peak detecting unit 13 outputs each of the detected peak positions pₘ to the reflection point detection processing unit 15.

Upon receiving each of the digital signals dₘ from the ADC 2, the azimuth detecting unit 14 detects an azimuth Azₘ of each object from each of the digital signals dₘ using an arrival direction estimation method such as a MUSIC method or an ESPRIT method.

That is, the azimuth detecting unit 14 obtains eigenvalues of a correlation matrix using a correlation matrix and an eigenvector of each of the digital signals dₘ, and estimates the number of reflected waves from the object from the number of eigenvalues larger than the thermal noise power, thereby detecting the azimuth Azₘ of the object.

The azimuth detecting unit 14 outputs the azimuth Azₘ of each object to the reflection point detection processing unit 15.

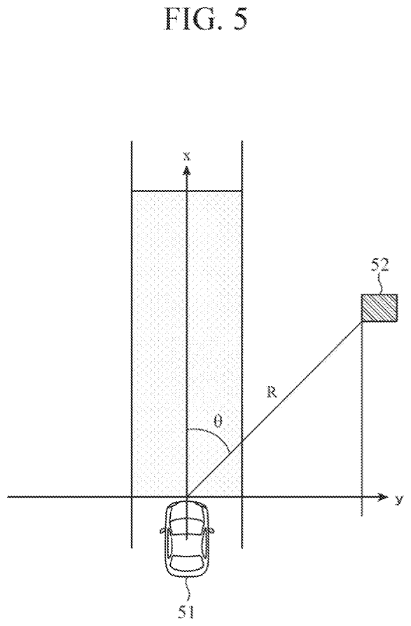

FIG. 5 is an explanatory diagram illustrating an azimuth of an object.

In FIG. 5, reference numeral 51 denotes a vehicle, and reference numeral 52 denotes an object.

The x-axis indicates a direction parallel to the traveling direction of the vehicle 51, and the y-axis indicates a direction orthogonal to the traveling direction of the vehicle 51.

θ is an angle formed between the traveling direction of the vehicle 51 and a direction along which the object 52 is viewed from the vehicle 51. When the absolute azimuth in the traveling direction of the vehicle 51 is α, θ+α is the relative azimuth of the object.

R is the relative distance between the vehicle and the object. R sin θ is, for example, a distance from a center line of the road to the object, and when R sin θ is longer than ½ of the road width, it is understood that the object is present outside the road. When R sin θ is ½ or less of the road width, it is understood that the object is present in the road.

The reflection point detection processing unit 15 acquires a relative distance Rdₘ corresponding to each of the peak positions pₘ detected by the peak detecting unit 13 from the FR map generated by the Fourier transform unit 12.

The reflection point detection processing unit 15 detects each of the reflection points refₘ from the relative distance Rdₘ corresponding to each of the peak positions pₘ and the azimuth Azₘ of each object detected by the azimuth detecting unit 14. Since the current position of the vehicle is known, the reflection point refₘ can be detected from the relative distance Rdₘ and the azimuth Azₘ.

The reflection point detection processing unit 15 outputs each of the detected reflection points refₘ to the group classifying unit 17.

The reflection point classifying unit 16 classifies, among the M reflection points refₘ outputted by the reflection point detecting unit 11, the reflection points of the object which are present in the area on the left side with respect to the traveling direction of the vehicle into the first group (step ST2 in FIG. 4).

The reflection point classifying unit 16 classifies, among the M reflection points refₘ outputted by the reflection point detecting unit 11, the reflection points of the object which are present in the area on the right side with respect to the traveling direction of the vehicle into the second group (step ST3 in FIG. 4).

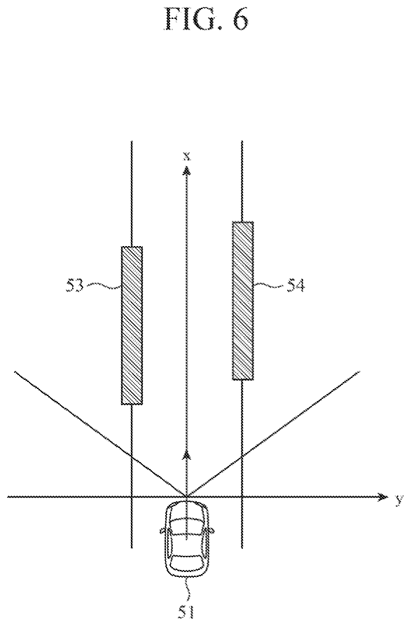

FIG. 6 is an explanatory diagram illustrating an object 53 present in an area on the left side with respect to the traveling direction of the vehicle and an object 54 present in an area on the right side with respect to the traveling direction of the vehicle.

A reflection point refₘ at any reflection position of the object 53 is classified into the first group related to the object 53, and a reflection point refₘ at any reflection position of the object 54 is classified into the second group related to the object 54.

Hereinafter, the processing of classifying the reflection points refₘ by the reflection point classifying unit 16 will be specifically described.

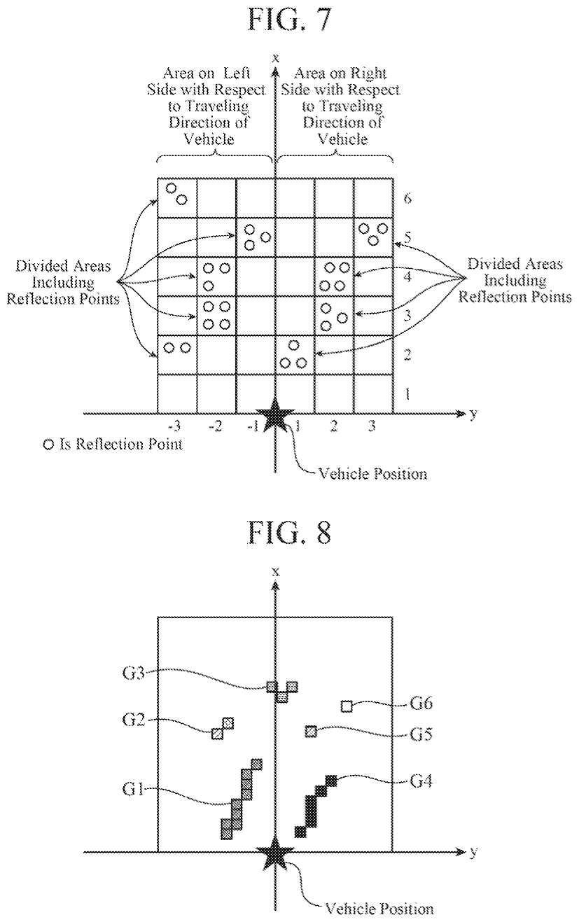

In the road shape estimation device 10 illustrated in FIG. 1, as shown in FIG. 7, the area around the vehicle is divided into a plurality of divided areas.

FIG. 7 is an explanatory diagram illustrating the plurality of divided areas.

The origin in FIG. 7 indicates the position of the vehicle. The x-axis indicates a direction parallel to the traveling direction of the vehicle, and the y-axis indicates a direction orthogonal to the traveling direction of the vehicle.

In FIG. 7, the area around the vehicle is divided into (6×6) divided areas. However, this is merely an example, and the area may be divided into more than (6×6) divided areas, or may be divided into less than (6×6) divided areas.

In addition, in FIG. 7, the shape of each divided area is a quadrangle. However, this is merely an example, and the shape of each divided area may be, for example, a triangle. Note that the coordinate system of the divided area may be any coordinate system, for example, a straight line orthogonal coordinate system or a curved line orthogonal coordinate system.

In FIG. 7, ∘ represents a reflection point refₘ detected by the reflection point detecting unit 11.

The group classifying unit 17 specifies divided areas including the reflection points refₘ detected by the reflection point detection processing unit 15.

In the group classifying unit 17, the coordinates indicating the positions of the divided areas are known.

In the example of FIG. 7, a reflection point refₘ is included in each of the divided area of coordinates (6, −3), the divided area of coordinates (5, −1), the divided area of coordinates (4, −2), the divided area of coordinates (3, −2), and the divided area of coordinates (2, −3).

Furthermore, a reflection point refₘ is included in each of the divided area of coordinates (5, 3), the divided area of coordinates (4, 2), the divided area of coordinates (3, 2), and the divided area of coordinates (2, 1).

The group classifying unit 17 performs processing of including, in one group, a set of divided areas, among the plurality of divided areas each including a reflection point refₘ, each being in contact with another divided area including a reflection point.

In the example of FIG. 7, the divided area of coordinates (5, −1), the divided area of coordinates (4, −2), the divided area of coordinates (3, −2), and the divided area of coordinates (2, −3) are included in one group (G1).

Furthermore, in the example of FIG. 7, the divided area of coordinates (5, 3), the divided area of coordinates (4, 2), the divided area of coordinates (3, 2), and the divided area of coordinates (1, 2) are included in one group (G2).

When the object is a road structure such as a guardrail, it is often disposed across a plurality of divided areas. Therefore, when radio waves are reflected by a road structure such as a guardrail, the number of divided areas included in one group is often two or more.

The group classifying unit 17 performs processing of including, in one group, a divided area, among the plurality of divided areas each including a reflection point refₘ, not in contact with another divided area including a reflection point.

In the example of FIG. 7, the divided area of coordinates (6, −3) is included in one group (G3).

For example, in a case of an object such as a postbox, it is often disposed in one divided area. Therefore, when a radio wave is reflected by an object such as a postbox, the number of divided areas included in one group is often one.

The group classifying unit 17 classifies each of the group (G1), the group (G2), and the group (G3) into the left group present in an area on the left side with respect to the traveling direction of the vehicle or the right group present in an area on the right side with respect to the traveling direction of the vehicle.

In the example of FIG. 7, since the group (G1) and the group (G3) are present in the area on the left side with respect to the traveling direction of the vehicle, the group (G1) and the group (G3) are classified into the left group. That is, since the signs of the y coordinates of all the divided areas included in the group (G1) are “−”, the group (G1) is classified into the left group. Similarly, since the sign of the y coordinate of the divided area included in the group (G3) is “−”, the group (G3) is classified into the left group.

In addition, since the group (G2) is present in the area on the right side with respect to the traveling direction of the vehicle, the group (G2) is classified into the right group. That is, since the signs of the y coordinates of all the divided areas included in the group (G2) are “+”, the group (G2) is classified into the right group.

In FIG. 7, for example, the signs of they coordinates of all the divided areas included in the group (G1) are “−”. However, in some cases, the signs of the y coordinates of some of the divided areas included in the group (G1) are “−”, and the signs of the y coordinates of the remaining divided areas are “+”. In such a case, the group classifying unit 17 focuses on, for example, a divided area having the smallest x coordinate among a plurality of divided areas included in the group (G1). Then, the group classifying unit 17 may classify the group (G1) into the left group when the sign of the y coordinate of the divided area having the smallest x coordinate is “−”, and may classify the group (G1) into the right group when the sign of the y coordinate of the divided area having the smallest x coordinate is “+”.

However, this classification is merely an example, and for example, when the number of divided areas present in the area on the left side with respect to the traveling direction of the vehicle is equal to or larger than the number of divided areas present in the area on the right side with respect to the traveling direction of the vehicle, the group classifying unit 17 may classify the group (G1) into the left group, and when the number of divided areas present in the area on the left side with respect to the traveling direction of the vehicle is smaller than the number of divided areas present in the area on the right side with respect to the traveling direction of the vehicle, the group classifying unit 17 may classify the group (G1) into the right group.

The group selecting unit 18 selects, among one or more groups classified into the left group by the group classifying unit 17, a group including the largest number of divided areas as the first group.

Since the group including a larger number of divided areas is more likely to be a road structure representing the shape of the road than the group including a smaller number of divided areas, a group including the largest number of divided areas is selected by the group selecting unit 18.

In the example of FIG. 7, the group (G1) and the group (G3) are classified into the left group. Then, since the number of divided areas included in the group (G1) is four and the number of divided areas included in the group (G3) is one, the group (G1) is selected as the first group.

The group selecting unit 18 selects, among one or more groups classified into the right group by the group classifying unit 17, a group including the largest number of divided areas as the second group.

In the example of FIG. 7, since only the group (G2) is classified into the right group, the group (G2) is selected as the second group.

In the example of FIG. 7, the number of divided areas included in the group (G1) is larger than the number of divided areas included in the group (G3). However, the number of divided areas included in the group (G1) and the number of divided areas included in the group (G3) may be the same. In such a case, the group selecting unit 18 selects the group (G1) or the group (G3) as the first group, for example, as follows.

The group selecting unit 18 specifies the divided area closest to the vehicle among a plurality of divided areas included in the group (G1), and calculates the distance L1 between the specified divided area and the vehicle. In addition, the group selecting unit 18 specifies the divided area closest to the vehicle among a plurality of divided areas included in the group (G3), and calculates the distance L3 between the specified divided area and the vehicle.

The group selecting unit 18 selects the group (G1) as the first group when the distance L1 is equal to or less than the distance L3, and selects the group (G3) as the first group when the distance L1 is longer than the distance L3.

FIG. 8 is an explanatory diagram illustrating an example in which a plurality of divided areas each including a reflection point refₘ are classified into six groups (G1) to (G6). The classification example illustrated in FIG. 8 is different from the classification example illustrated in FIG. 7.

In the example of FIG. 8, the group (G1) and the group (G2) are classified into the left group and the group (G3) to the group (G6) are classified into the right group by the group classifying unit 17.

Some of the divided areas included in the group (G3) are present in the area on the left side with respect to the traveling direction of the vehicle, and the remaining divided areas are present in the area on the right side with respect to the traveling direction of the vehicle. Since the sign of they coordinate of the divided area having the smallest x coordinate among the plurality of divided areas included in the group (G3) is “+”, the group (G3) is classified into the right group.

In the example of FIG. 8, the group selecting unit 18 selects the group (G1) as the first group and selects the group (G4) as the second group.

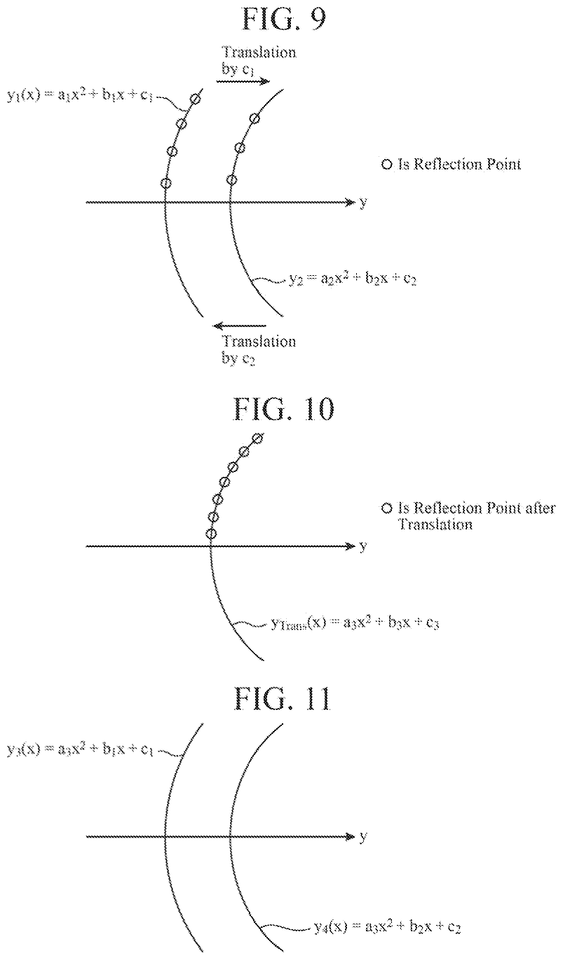

As illustrated in FIG. 9, the translation unit 19 acquires all the reflection points refᵢ classified into the first group from the reflection point classifying unit 16. i=1, . . . , 1, and I is an integer of 1 or more.

As illustrated in FIG. 9, the translation unit 19 acquires all the reflection points refⱼ classified into the second group from the reflection point classifying unit 16. j=1, . . . , 1, and J is an integer of 1 or more. I+J=M.

FIG. 9 is an explanatory diagram illustrating the reflection point refᵢ and the reflection point refⱼ, and a first approximate curve y₁(x) and a second approximate curve y₂(x).

In the example of FIG. 9, the translation unit 19 acquires four reflection points refᵢ and acquires three reflection points refⱼ.

The translation unit 19 calculates a first approximate curve y₁(x) representing a point cloud including all the reflection points refᵢ classified into the first group as expressed by the following Formula (1) using, for example, the least squares method.

y₁(x)=a₁x²+b₁x+c₁ (1)

In Formula (1), a₁ is a quadratic coefficient, b₁ is a linear coefficient, and c₁ is a constant term.

Here, since the translation unit 19 has acquired three or more reflection points refᵢ, the first approximate curve y₁(x) as expressed in Formula (1) is calculated. In a case where the number of reflection points refᵢ classified into the first group is two, a quadratic curve cannot be calculated, and thus, a first approximate curve y₁(x) as shown in the following Formula (2) is calculated.

y₁(x)=d₁x+e₁ (2)

In Formula (2), d₁ is a linear coefficient, and e₁ is a constant term.

Furthermore, in a case where the number of reflection points refᵢ classified into the first group is one, a first approximate curve y₁(x) as shown in the following Formula (3) is calculated.

y₁(x)=g₁ (3)

In Formula (3), g₁ is a constant term and is a value of the y coordinate at the reflection point refᵢ.

The translation unit 19 calculates a second approximate curve y₂(x) representing a point cloud including all the reflection points refⱼ classified into the second group as expressed by the following Formula (4) using, for example, the least squares method.

y₂(x)=a₂x²+b₂x+c₂ (4)

In Formula (4), a₂ is a quadratic coefficient, b₂ is a linear coefficient, and c₂ is a constant term.

Here, since the translation unit 19 has acquired three or more reflection points refⱼ, a second approximate curve y₂(x) as expressed in Formula (4) is calculated. In a case where the number of reflection points refⱼ classified into the second group is two, a quadratic curve cannot be calculated, and thus, a second approximate curve y₂(x) as expressed in the following Formula (5) is calculated.

y₂(x)=d₂x+e₂ (5)

In Formula (5), d₂ is a linear coefficient, and e₂ is a constant term.

Furthermore, in a case where the number of reflection points refⱼ classified into the second group is one, a second approximate curve y₂(x) as expressed in the following Formula (6) is calculated.

y₂(x)=g₂ (6)

In Formula (6), g₂ is a constant term and is a value of the y coordinate at the reflection point refⱼ.

After calculating the first approximate curve y₁(x) expressed by Formula (1), as illustrated in FIG. 9, the translation unit 19 translates each of the reflection points refᵢ classified into the first group by a value of the constant term c₁ in the first approximate curve y₁(x) to the right direction (+Y direction) of the vehicle (step ST4 in FIG. 4).

After calculating the first approximate curve y₁(x) expressed by Formula (2), the translation unit 19 translates each of the reflection points refᵢ classified into the first group by a value of the constant term e₁ in the first approximate curve y₁(x) to the right direction (+Y direction) of the vehicle.

After calculating the first approximate curve y₁(x) expressed by Formula (3), the translation unit 19 translates the reflection point refᵢ classified into the first group by a value of the constant term g₁ in the first approximate curve y₁(x) to the right direction (+Y direction) of the vehicle.

After calculating the second approximate curve y₂(x) expressed by Formula (4), as illustrated in FIG. 9, the translation unit 19 translates each of the reflection points refⱼ classified into the second group by a value of the constant term c₂ in the second approximate curve y₂(x) to the left direction (−Y direction) of the vehicle (step ST5 in FIG. 4).

After calculating the second approximate curve y₂(x) expressed by Formula (5), the translation unit 19 translates each of the reflection points refⱼ classified into the second group by a value of the constant term e₂ in the second approximate curve y₂(x) to the left direction (−Y direction) of the vehicle.

After calculating the second approximate curve y₂(x) expressed by Formula (6), the translation unit 19 translates the reflection point refⱼ classified into the second group by a value of the constant term g₂ in the second approximate curve y₂(x) to the left direction (−Y direction) of the vehicle.

When each of the reflection points refᵢ is translated in the +Y direction by the value of the constant term c₁ and each of the reflection points refⱼ is translated in the −Y direction by the value of the constant term c₂, as illustrated in FIG. 10, each of the reflection points refᵢ after translation and each of the reflection points refⱼ after translation are substantially located on one approximate curve. In general, the number of reflection points located on one approximate curve is M (=I+J).

FIG. 10 is an explanatory diagram illustrating the reflection points refᵢ after translation and the reflection points refⱼ after translation, and an approximate curve representing a point cloud including all the reflection points refᵢ and refⱼ after translation.

Note that, in a case where the first approximate curve y₁(x) is an approximate curve expressed by Formula (1) and the second approximate curve y₂(x) is an approximate curve expressed by Formula (5) or an approximate curve expressed by Formula (6), each of the reflection points refⱼ after translation may not be located on an approximate curve representing a point cloud including all the reflection points refᵢ after translation. However, each of the reflection points refⱼ after translation is located in the vicinity of the approximate curve.

Furthermore, in a case where the second approximate curve y₂(x) is an approximate curve expressed by Formula (4) and the first approximate curve y₁(x) is an approximate curve expressed by Formula (2) or an approximate curve expressed by Formula (3), each of the reflection points refᵢ after translation may not be located on an approximate curve representing a point cloud including all the reflection points refⱼ after translation. However, each of the reflection points refᵢ after translation is located in the vicinity of the approximate curve.

The road shape estimating unit 20 calculates an approximate curve y_{Trans}(x) representing a point cloud including all reflection points refᵢ and refⱼ after translation by the translation unit 19, and estimates the shape of the road on which the vehicle travels from the approximate curve y_{Trans}(x).

Hereinafter, road shape estimation processing by the road shape estimating unit 20 will be specifically described.

For example, the approximate curve calculating unit 21 calculates an approximate curve y_{Trans}(x) representing a point cloud including all the reflection points refᵢ and refⱼ after translation as expressed by the following Formula (7) using the least squares method (step ST6 in FIG. 4).

y_{Trans}(x)=a₃x²+b₃x+c₃ (7)

In Formula (7), a₃ is a quadratic coefficient, b₃ is a linear coefficient, and c₃ is a constant term.

The number of reflection points refᵢ and refⱼ after translation is M (=I+J), which is larger than the number of reflection points refᵢ and is larger than the number of reflection points refⱼ. Therefore, even in a case where either the number of reflection points refᵢ or the number of reflection points refⱼ is less than three, the number of reflection points refᵢ and refⱼ after translation is three or more, and the approximate curve y_{Trans}(x) may be calculated.

The shape estimation processing unit 22 calculates, as expressed by the following Formula (8), a third approximate curve y₃(x) represented by the quadratic coefficient a₃ indicating the curvature of the approximate curve y_{Trans}(x) calculated by the approximate curve calculating unit 21 and the linear coefficient b₁ and the constant term c₁ of the first approximate curve y₁(x) calculated by the translation unit 19.

y₃(x)=a₃x²+b₁x+c₁ (8)

In addition, the shape estimation processing unit 22 calculates, as expressed by the following Formula (9), a fourth approximate curve y₄(x) represented by the quadratic coefficient a₃ indicating the curvature of the approximate curve y_{Trans}(x) and the linear coefficient b₂ and the constant term c₂ of the second approximate curve y₂(x) calculated by the translation unit 19.

y₄(x)=a₃x²+b₂x+c₂ (9)

FIG. 11 is an explanatory diagram illustrating the third approximate curve y₃(x) and the fourth approximate curve y₄(x).

The shape estimation processing unit 22 estimates the shape of the road on which the vehicle travels from the third approximate curve y₃(x) and the fourth approximate curve y₄(x) (step ST7 in FIG. 4).

That is, the shape estimation processing unit 22 estimates that the curve shape indicated by the third approximate curve y₃(x) is the shape of the left edge of the road, and estimates that the curve shape indicated by the fourth approximate curve y₄(x) is the shape of the right edge of the road.

The shape estimation processing unit 22 outputs the estimation result of the road shape to, for example, a control device (not illustrated) of the vehicle.

The control device of the vehicle can control the steering of the vehicle by using the estimation result of the road shape, for example, when autonomously driving the vehicle.

After estimating the shape of the road, the shape estimation processing unit 22 may determine whether or not each of the group (G2), the group (G3), the group (G5), and the group (G6) not selected by the group selecting unit 18 is present between the curve shape indicated by the third approximate curve y₃(x) and the curve shape indicated by the fourth approximate curve y₄(x).

In the shape estimation processing unit 22, the coordinates in the group (G2), the group (G3), the group (G5), and the group (G6) are known. Therefore, the shape estimation processing unit 22 can determine whether or not each of the group (G2), the group (G3), the group (G5), and the group (G6) is present between the curve shape indicated by the third approximate curve y₃(x) and the curve shape indicated by the fourth approximate curve y₄(x).

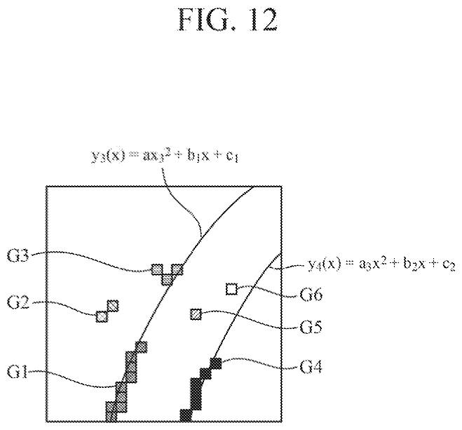

FIG. 12 is an explanatory diagram for describing processing of determining whether or not an object is present in a road.

In the example of FIG. 12, it is determined that the object related to the group (G2) is not present between the curve shape indicated by the third approximate curve y₃(x) and the curve shape indicated by the fourth approximate curve y₄(x). That is, it is determined that the object related to the group (G2) is present outside the road.

It is determined that the object related to each of the group (G5) and the group (G6) is present between the curve shape indicated by the third approximate curve y₃(x) and the curve shape indicated by the fourth approximate curve y₄(x). That is, it is determined that the object related to each of the group (G5) and the group (G6) is present in the road.

It is determined that a part of the object related to the group (G3) is present between the curve shape indicated by the third approximate curve y₃(x) and the curve shape indicated by the fourth approximate curve y₄(x), and a part of the object related to the group (G3) is not present between the curve shape indicated by the third approximate curve y₃(x) and the curve shape indicated by the fourth approximate curve y₄(x). That is, it is determined that a part of the object related to the group (G3) is present in the road.

In the first embodiment described above, the road shape estimation device 10 is configured to include: the reflection point detecting unit 11 to detect, from received signals of a plurality of radio waves reflected by an object present around a vehicle, a reflection point indicating a reflection position of each of the radio waves on the object; the reflection point classifying unit 16 to classify, among the plurality of reflection points detected by the reflection point detecting unit 11, reflection points of an object present in an area on a left side with respect to a traveling direction of the vehicle into a first group, and classify reflection points of an object present in an area on a right side with respect to the traveling direction of the vehicle into a second group; the translation unit 19 to translate each of the reflection points classified into the first group by the reflection point classifying unit 16 to a right direction of the vehicle orthogonal to the traveling direction of the vehicle, and translate each of the reflection points classified into the second group by the reflection point classifying unit 16 to a left direction of the vehicle orthogonal to the traveling direction of the vehicle; and the road shape estimating unit 20 to calculate an approximate curve representing a point cloud including all reflection points after translation by the translation unit 19 and estimate, from the approximate curve, a shape of a road on which the vehicle travels. Therefore, the road shape estimation device 10 may be able to estimate the shape of the road even when the number of left side reflection points or the number of right side reflection points is small.

In the road shape estimation device 10 illustrated in FIG. 1, as illustrated in FIG. 9, the translation unit 19 calculates a first approximate curve y₁(x) representing a point cloud including all the reflection points refs classified into the first group, and calculates a second approximate curve y₂(x) representing a point cloud including all the reflection points refⱼ classified into the second group.

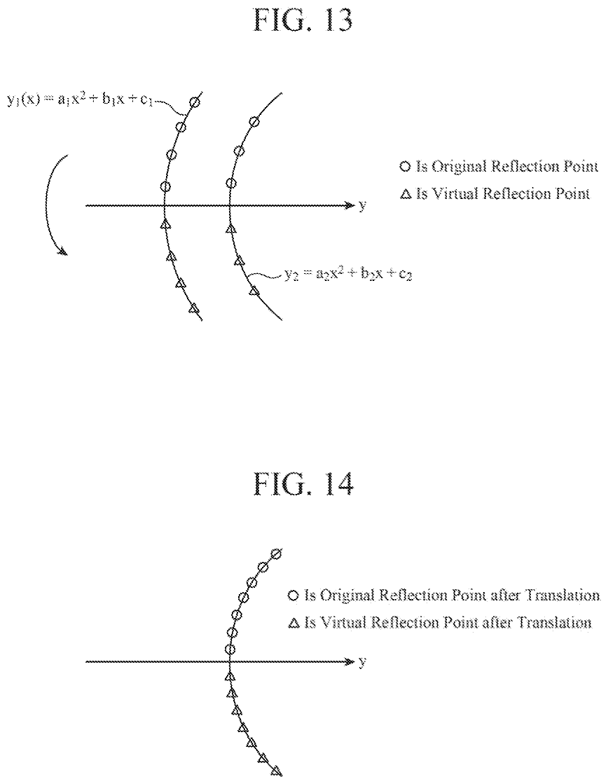

However, this is merely an example, and as illustrated in FIG. 13, the translation unit 19 may generate a virtual reflection point refᵢ by copying all the reflection points refᵢ classified into the first group with the y axis as the symmetry axis to the area where the x coordinate is negative. Furthermore, as illustrated in FIG. 13, the translation unit 19 may generate a virtual reflection point refⱼ by copying all the reflection points refⱼ classified into the second group with the y axis as the symmetry axis to the area where the x coordinate is negative. By generating the virtual reflection point refᵢ, the number of reflection points refᵢ is doubled, and by generating the virtual reflection point refⱼ, the number of reflection points refⱼ is doubled.

FIG. 13 is an explanatory diagram illustrating original reflection points refᵢ and refⱼ and virtual reflection points refᵢ and refⱼ. In FIG. 13, ∘ represents original reflection points refᵢ and refⱼ and Δ represents virtual reflection points refᵢ and refⱼ.

The y coordinate of the virtual reflection point refᵢ is the same as the y coordinate of the original reflection point refᵢ, and the x coordinate of the virtual reflection point refᵢ is a value obtained by multiplying the x coordinate of the original reflection point refᵢ by “−1”.

Furthermore, the y coordinate of the virtual reflection point refⱼ is the same as the y coordinate of the original reflection point refⱼ, and the x coordinate of the virtual reflection point refⱼ is a value obtained by multiplying the x coordinate of the original reflection point refⱼ by “−1”.

As expressed by Formula (1), the translation unit 19 calculates the first approximate curve y₁(x) representing a point cloud including all the original reflection points refᵢ and all the virtual reflection points refⱼ.

As expressed by Formula (4), the translation unit 19 calculates the second approximate curve y₂(x) representing a point cloud including all the original reflection points refⱼ and all the virtual reflection points refⱼ.

Since the number of reflection points refᵢ is doubled, the calculation accuracy of the first approximate curve y₁(x) is improved as compared with the first approximate curve y₁(x) representing the point cloud that does not include the virtual reflection point refᵢ. In addition, since the number of reflection points refⱼ is doubled, the calculation accuracy of the second approximate curve y₂(x) is improved as compared with the second approximate curve y₂(x) representing the point cloud that does not include the virtual reflection point refⱼ.

As illustrated in FIG. 14, the approximate curve calculating unit 21 calculates an approximate curve y_{Trans}(x) representing a point cloud including all the reflection points refᵢ and refⱼ after translation by the translation unit 19.

FIG. 14 is an explanatory diagram illustrating an approximate curve y_{Trans}(x) representing a point cloud including all the reflection points refᵢ and refⱼ after translation by the translation unit 19. In FIG. 14, ◯ represents original reflection points refᵢ and refⱼ after translation, and Δ represents virtual reflection points refᵢ and refⱼ after translation.

In the road shape estimation device 10 illustrated in FIG. 1, the translation unit 19 calculates a first approximate curve y₁(x) representing a point cloud including all the reflection points refᵢ classified into the first group, and calculates a second approximate curve y₂(x) representing a point cloud including all the reflection points refⱼ classified into the second group.

The translation unit 19 may calculate a first approximate curve y₁(x) representing a point cloud including representative reflection points refᵤ in all the divided areas included in the first group, and may calculate a second approximate curve y₂(x) representing a point cloud including representative reflection points refᵥ in all the divided areas included in the second group.

When the number of divided areas included in the first group is M or more, the first approximate curve y₁(x) indicating the quadratic curve can be calculated from the point cloud including the representative reflection points refᵤ in all the divided areas included in the first group.

Furthermore, when the number of divided areas included in the second group is M or more, the second approximate curve y₂(x) indicating the quadratic curve can be calculated from the point cloud including the representative reflection points refᵤ in all the divided areas included in the second group.

u=1, . . . , U, where U is the number of divided areas included in the first group. v=1, . . . , V, where V is the number of divided areas included in the second group.

The translation unit 19 extracts one representative reflection point refᵤ from among a plurality of reflection points refᵢ in each of the divided areas included in the first group. The representative reflection point refᵤ may be, for example, a reflection point closest to the center of gravity of the plurality of reflection points refᵢ among the plurality of reflection points refᵢ, or may be a reflection point having the shortest distance to the vehicle.

Furthermore, the translation unit 19 extracts one representative reflection point refᵥ from among a plurality of reflection points refⱼ in each of the divided areas included in the second group. The representative reflection point refᵥ may be, for example, a reflection point closest to the center of gravity of the plurality of reflection points refⱼ among the plurality of reflection points refⱼ, or may be a reflection point having the shortest distance to the vehicle.

FIG. 15 is an explanatory diagram illustrating divided areas included in each of the first group and the second group, and a first approximate curve y₁(x) and a second approximate curve y₂(x).

The translation unit 19 calculates, as expressed in the following Formula (10), a first approximate curve y₁(x) representing a point cloud including the representative reflection points refᵤ in all the divided areas included in the first group.

y₁(x)=a₁′x²+b₁′x+c₁′ (10)

In Formula (3), a₁′ is a quadratic coefficient, b₁′ is a linear coefficient, and c₁′ is a constant term.

Furthermore, the translation unit 19 calculates, as expressed in the following Formula (11), a second approximate curve y₂(x) representing a point cloud including the representative reflection points refᵥ in all the divided areas included in the second group.

y₂(x)=a₂′x²+b₂′x+c₂′ (11)

In Formula (4), a₂′ is a quadratic coefficient, b₂′ is a linear coefficient, and c₂′ is a constant term.

After calculating the first approximate curve y₁(x), the translation unit 19, as illustrated in FIG. 15, translates each of the representative reflection points refᵤ by a value of the constant term c₁′ in the first approximate curve y₁(x) to the right direction (+Y direction) of the vehicle.

After calculating the second approximate curve y₂(x), the translation unit 19, as illustrated in FIG. 15, translates each of the representative reflection points refᵥ by a value of the constant term c₂′ in the second approximate curve y₂(x) to the left direction (−Y direction) of the vehicle.

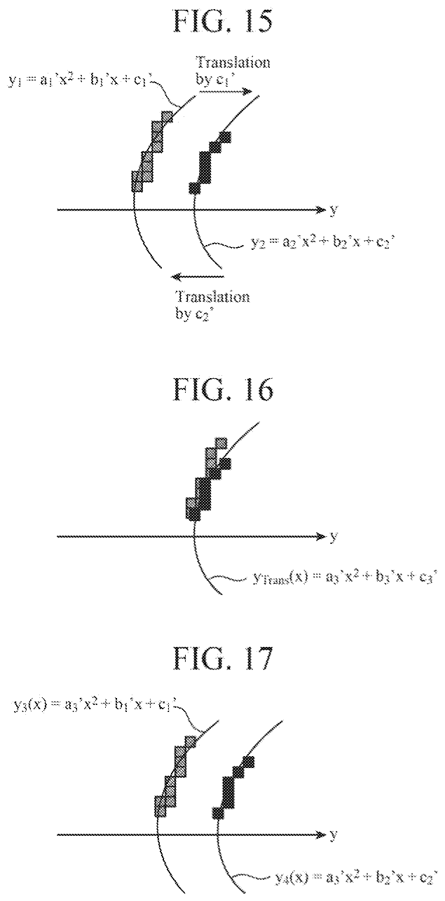

FIG. 16 is an explanatory diagram illustrating divided areas including reflection points refᵤ and refᵥ after translation and an approximate curve representing a point cloud including all the reflection points refᵤ and refᵥ after translation.

The approximate curve calculating unit 21 calculates, for example, an approximate curve y_{Trans}(x) representing a point cloud including all the reflection points refᵤ and refᵥ after translation as expressed by the following Formula (12) using the least squares method.

y_{Trans}(x)=a₃′x²+b₃′x+c₃′ (12)

In Formula (12), a₃′ is a quadratic coefficient, b₃′ is a linear coefficient, and c₃′ is a constant term.

The shape estimation processing unit 22, as expressed by the following Formula (13), calculates a third approximate curve y₃(x) represented by the quadratic coefficient a₃′ indicating the curvature of the approximate curve y_{Trans}(x) calculated by the approximate curve calculating unit 21 and the linear coefficient b₁′ and the constant term c₁′ of the first approximate curve y₁(x) calculated by the translation unit 19.

y₃(x)=a₃′x²+b₁′x+c₁′ (13)

In addition, the shape estimation processing unit 22, as expressed by the following Formula (14), calculates a fourth approximate curve y₄(x) represented by the quadratic coefficient a₃′ indicating the curvature of the approximate curve y_{Trans}(x) and the linear coefficient b₂′ and the constant term c₂′ of the second approximate curve y₂(x) calculated by the translation unit 19.

y₄(x)=a₃′x²+b₂′x+c₂′ (14)

FIG. 17 is an explanatory diagram illustrating the third approximate curve y₃(x) and the fourth approximate curve y₄(x).

The shape estimation processing unit 22 estimates the shape of the road on which the vehicle travels from the third approximate curve y₃(x) and the fourth approximate curve y₄(x).

### Second Embodiment

In a second embodiment, a road shape estimation device 10 will be described in which the road shape estimating unit 20 estimates the shape of the road assuming that the direction of the road at the position where the vehicle is present is parallel to the traveling direction of the vehicle.

The configuration of the road shape estimation device 10 according to the second embodiment is similar to the configuration of the road shape estimation device 10 according to the first embodiment, and a configuration diagram illustrating the road shape estimation device 10 according to the second embodiment is illustrated in FIG. 1.

Next, an operation of the road shape estimation device 10 according to the second embodiment will be described.

Since the operations of the reflection point detecting unit 11 and the reflection point classifying unit 16 are similar to those in the first embodiment, the description thereof will be omitted.

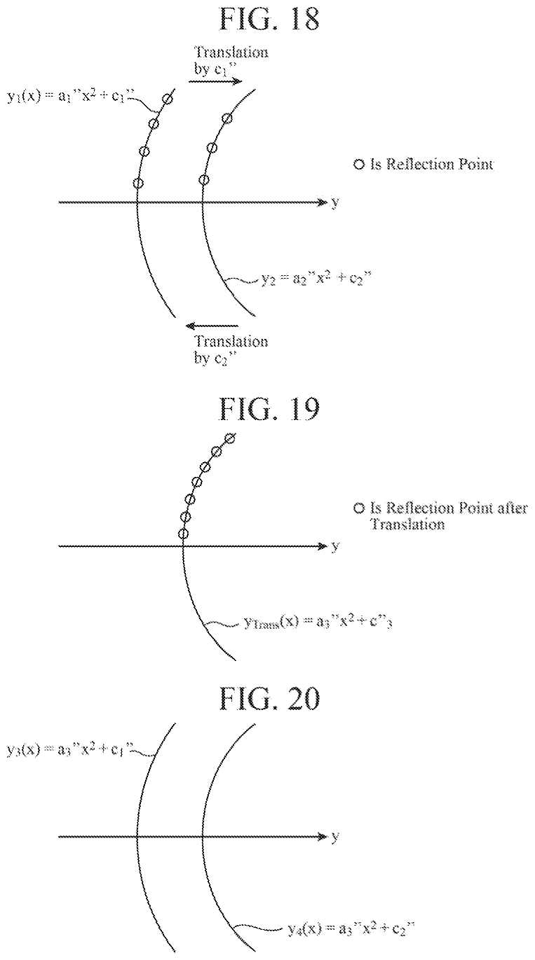

As illustrated in FIG. 18, the translation unit 19 acquires all the reflection points refᵢ classified into the first group from the reflection point classifying unit 16.

As illustrated in FIG. 18, the translation unit 19 acquires all the reflection points refⱼ classified into the second group from the reflection point classifying unit 16.

FIG. 18 is an explanatory diagram illustrating the reflection points refᵢ and the reflection points refⱼ, and the first approximate curve y₁(x) and the second approximate curve y₂(x).

In the example of FIG. 18, the translation unit 19 acquires four reflection points refᵢ and acquires three reflection points refⱼ.

The translation unit 19, as expressed by the following Formula (15), calculates a first approximate curve y₁(x) representing a point cloud including all the reflection points refᵢ classified into the first group.

The translation unit 19 calculates the first approximate curve y₁(x) with a constraint condition that the direction of the road at the position where the vehicle is present is parallel to the traveling direction of the vehicle. Therefore, the first approximate curve y₁(x) expressed in Formula (15) does not include a linear term.

The direction of the road is a tangential direction with respect to the left edge of the road in which the coordinate of the x axis is “0”, or a tangential direction with respect to the right edge of the road in which the coordinate of the x axis is “0”. However, here, for simplification of description, it is assumed that a tangential direction with respect to the left edge of the road and a tangential direction with respect to the right edge of the road are the same direction.

Therefore, the fact that the direction of the road is parallel to the traveling direction of the vehicle means that the tangential direction is parallel to the traveling direction of the vehicle.

y₁(x)=a₁″x²+c₁″ (15)

In Formula (15), a₁″ is a quadratic coefficient, and c₁″ is a constant term.

Furthermore, the translation unit 19, as expressed in the following Formula (16), calculates a second approximate curve y₂(x) representing a point cloud including all the reflection points refⱼ classified into the second group.

The translation unit 19 calculates the second approximate curve y₂(x) with a constraint condition that the direction of the road at the position where the vehicle is present is parallel to the traveling direction of the vehicle.

y₂(x)=a₂″x²+c₂″ (16)

In Formula (16), a₂″ is a quadratic coefficient, and c₂″ is a constant term.

After calculating the first approximate curve y₁(x) expressed by Formula (15), the translation unit 19, as illustrated in FIG. 18, translates each of the reflection points refᵢ classified into the first group by a value of the constant term c₁″ in the first approximate curve y₁(x) to the right direction (+Y direction) of the vehicle.

After calculating the second approximate curve y₂(x) expressed by Formula (16), the translation unit 19, as illustrated in FIG. 18, translates each of the reflection points refⱼ classified into the second group by a value of the constant term c₂″ in the second approximate curve y₂(x) to the left direction (−Y direction) of the vehicle.

When each of the reflection points refᵢ is translated by the value of the constant term c₁″ in the +Y direction and each of the reflection points refⱼ is translated by the value of the constant term c₂″ in the −Y direction, as illustrated in FIG. 19, each of the reflection points refᵢ after translation and each of the reflection points refⱼ after translation are substantially located on one approximate curve. In general, the number of reflection points located on one approximate curve is M (=I+J).

FIG. 19 is an explanatory diagram illustrating the reflection points refᵢ after translation and the reflection points refⱼ after translation, and an approximate curve representing a point cloud including all the reflection points refᵢ and refⱼ after translation.

The road shape estimating unit 20 calculates an approximate curve y_{Trans}(x) representing a point cloud including all the reflection points refᵢ and refⱼ after translation by the translation unit 19 after providing a constraint condition that the direction of the road at the position where the vehicle is present is parallel to the traveling direction of the vehicle.

The road shape estimating unit 20 estimates the shape of the road on which the vehicle travels from the approximate curve y_{Trans}(x).

Hereinafter, road shape estimation processing by the road shape estimating unit 20 will be specifically described.

The approximate curve calculating unit 21, as expressed by the following Formula (17), calculates an approximate curve y_{Trans}(x) representing a point cloud including all the reflection points refᵢ and refⱼ after translation.

The approximate curve calculating unit 21 calculates the approximate curve y_{Trans}(x) with a constraint condition that the direction of the road at the position where the vehicle is present is parallel to the traveling direction of the vehicle. Therefore, the approximate curve y_{Trans}(x) expressed in Formula (17) does not include the linear term.

y_{Trans}(x)=a₃″x²+c₃″ (17)

In Formula (17), a₃″ is a quadratic coefficient, and c₃″ is a constant term.

The shape estimation processing unit 22, as expressed by the following Formula (18), calculates a third approximate curve y₃(x) represented by the quadratic coefficient a₃″ indicating the curvature of the approximate curve y_{Trans}(x) calculated by the approximate curve calculating unit 21 and the constant term c₁″ in the first approximate curve y₁(x) calculated by the translation unit 19.

y₃(x)=a₃″x²+c₁″ (18)

In addition, the shape estimation processing unit 22, as expressed by the following Formula (19), calculates a fourth approximate curve y₄(x) represented by the quadratic coefficient as indicating the curvature of the approximate curve y_{Trans}(x) and the constant term c₂″ in the second approximate curve y₂(x) calculated by the translation unit 19.

y₄(x)=a₃″x²+c₂″ (19)

FIG. 20 is an explanatory diagram illustrating the third approximate curve y₃(x) and the fourth approximate curve y₄(x).

The shape estimation processing unit 22 estimates the shape of the road on which the vehicle travels from the third approximate curve y₃(x) and the fourth approximate curve y₄(x).

That is, the shape estimation processing unit 22 estimates that the curve shape indicated by the third approximate curve y₃(x) is the shape of the left edge of the road, and estimates that the curve shape indicated by the fourth approximate curve y₄(x) is the shape of the right edge of the road.

The shape estimation processing unit 22 outputs the estimation result of the road shape to, for example, a control device (not illustrated) of the vehicle.

In the second embodiment described above, the road shape estimation device 10 is configured so that the road shape estimating unit 20 estimates the shape of the road assuming that the direction of the road at the position where the vehicle is present is parallel to the traveling direction of the vehicle. Therefore, in the road shape estimation device 10 according to the second embodiment, the load of calculating the approximate curve used for estimating the road shape is reduced as compared with the road shape estimation device 10 according to the first embodiment.

### Third Embodiment

In a third embodiment, a road shape estimation device 10 will be described in which a road shape estimating unit 23 calculates an approximate curve representing a point cloud including all reflection points after translation by the translation unit 19, then corrects the calculated approximate curve using the approximate curve calculated last time, and estimates the shape of the road on which the vehicle travels from the corrected approximate curve.

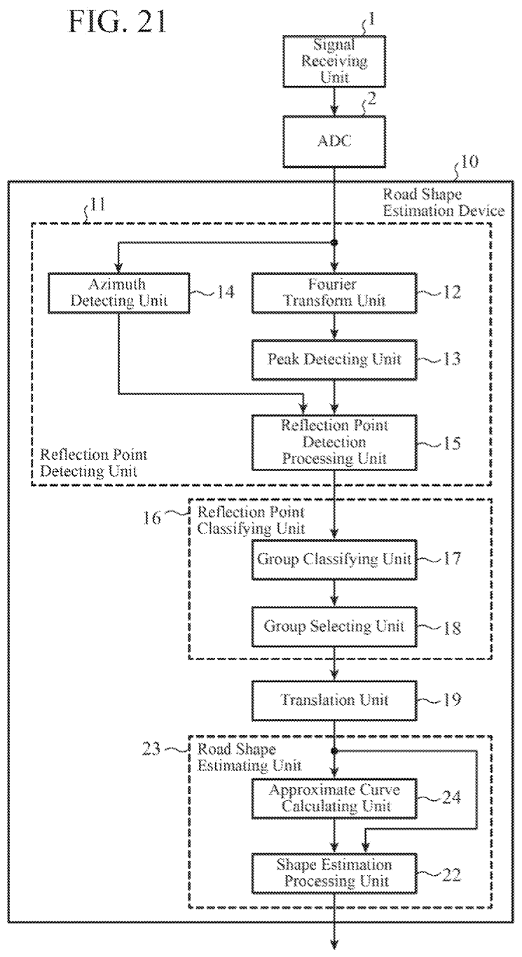

FIG. 21 is a configuration diagram illustrating the road shape estimation device 10 according to the third embodiment. In FIG. 21, the same reference numerals as those in FIG. 1 denote the same or corresponding parts, and thus description thereof is omitted.

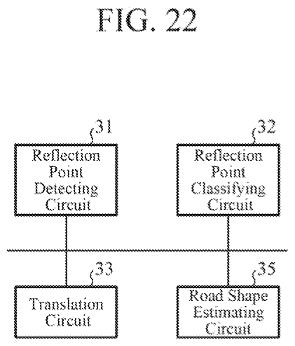

FIG. 22 is a hardware configuration diagram illustrating hardware of the road shape estimation device 10 according to the third embodiment. In FIG. 22, the same reference numerals as those in FIG. 2 denote the same or corresponding parts, and thus description thereof is omitted.

The road shape estimating unit 23 is implemented by, for example, a road shape estimating circuit 35 illustrated in FIG. 22.

The road shape estimating unit 23 includes an approximate curve calculating unit 24 and the shape estimation processing unit 22.

Similarly to the road shape estimating unit 20 illustrated in FIG. 1, the road shape estimating unit 23 calculates an approximate curve representing a point cloud including all reflection points after translation by the translation unit 19.

The road shape estimating unit 23 corrects the calculated approximate curve using the approximate curve calculated last time, and estimates the shape of the road on which the vehicle travels from the corrected approximate curve.

Similarly to the approximate curve calculating unit 21 illustrated in FIG. 1, the approximate curve calculating unit 24 calculates an approximate curve representing a point cloud including all reflection points after translation by the translation unit 19.

The approximate curve calculating unit 24 corrects the calculated approximate curve using the approximate curve calculated last time.

The approximate curve calculating unit 24 outputs the corrected approximate curve to the shape estimation processing unit 22.

In FIG. 21, it is assumed that each of the reflection point detecting unit 11, the reflection point classifying unit 16, the translation unit 19, and the road shape estimating unit 23, which are components of the road shape estimation device 10, is implemented by dedicated hardware as illustrated in FIG. 22. That is, it is assumed that the road shape estimation device 10 is implemented by the reflection point detecting circuit 31, the reflection point classifying circuit 32, the translation circuit 33, and the road shape estimating circuit 35.

Each of the reflection point detecting circuit 31, the reflection point classifying circuit 32, the translation circuit 33, and the road shape estimating circuit 35 corresponds to, for example, a single circuit, a composite circuit, a programmed processor, a parallel-programmed processor, ASIC, FPGA, or a combination thereof.

The components of the road shape estimation device 10 are not limited to those implemented by dedicated hardware, and the road shape estimation device 10 may be implemented by software, firmware, or a combination of software and firmware.

When the road shape estimation device 10 is implemented by software, firmware, or the like, a road shape estimation program for causing a computer to execute a processing procedure performed in each of the reflection point detecting unit 11, the reflection point classifying unit 16, the translation unit 19, and the road shape estimating unit 23 is stored in a memory 41 illustrated in FIG. 3. Then, the processor 42 illustrated in FIG. 3 executes the road shape estimation program stored in the memory 41.

In addition, FIG. 22 illustrates an example in which each of the components of the road shape estimation device 10 is implemented by dedicated hardware, and FIG. 3 illustrates an example in which the road shape estimation device 10 is implemented by software, firmware, or the like. However, this is merely an example, and some components in the road shape estimation device 10 may be implemented by dedicated hardware, and the remaining components may be implemented by software, firmware, or the like.

Next, the operation of the road shape estimation device 10 illustrated in FIG. 21 will be described. Since the road shape estimation device 10 is similar to the road shape estimation device 10 illustrated in FIG. 1 except for the road shape estimating unit 23, only the operation of the road shape estimating unit 23 will be described here.

Similarly to the approximate curve calculating unit 21 illustrated in FIG. 1, the approximate curve calculating unit 24 of the road shape estimating unit 23 calculates an approximate curve y_{Trans}(x) representing a point cloud including all reflection points after translation by the translation unit 19.

The approximate curve y_{Trans}(x) calculated by the approximate curve calculating unit 24 may vary greatly every time it is calculated. When the approximate curve y_{Trans}(x) varies, the estimation result of the road shape by the shape estimation processing unit 22 may become unstable.

In order to suppress the variation of the approximate curve y_{Trans}(x), the approximate curve calculating unit 24 corrects the calculated approximate curve y_{Trans}(x) using the approximate curve y_{Trans}(x) calculated in the past.

Hereinafter, the correction processing of the approximate curve y_{Trans}(x) by the approximate curve calculating unit 24 will be specifically described.

The approximate curve calculating unit 24 sets the latest approximate curve y_{Trans}(x) calculated this time as an n-th frame approximate curve y_{Trans}(x)ₙ, and sets the last calculated approximate curve y_{Trans}(x) as an (n−1)-th frame approximate curve y_{Trans}(x)ₙ₋₁. n is an integer of 2 or more.

The quadratic coefficient, the linear coefficient, and the constant term in the n-th frame approximate curve y_{Trans}(x)ₙ are expressed as a_{1,n}, b_{1,n}, and c_{1,n}, respectively.

In addition, the quadratic coefficient, the linear coefficient, and the constant term in the (n−1)-th frame approximate curve y_{Trans}(x)ₙ₋₁ are expressed as a_{1,n-1}, b_{1,n-1}, and c_{1,n-1}, respectively.

The approximate curve calculating unit 24 corrects an n-th frame approximate curve y_{Trans}(x).

That is, the approximate curve calculating unit 24, as expressed in the following Formula (20), uses the quadratic coefficient a_{1,n-1}, the linear coefficient b_{1,n-1}, and the constant term c_{1,n-1} in the (n−1)-th frame approximate curve y_{Trans}(x)ₙ₋₁ to correct the quadratic coefficient a_{1,n}, the linear coefficient b_{1,n}, and the constant term c_{1,n} in the n-th frame approximate curve y_{Trans}(x)ₙ.

$$Corrected {a}_{1 , n} = \frac{{a}_{1 , n - 1} \times ( n - 1 ) + {a}_{1 , n}}{n} \qquad ( 20 )$$

$$Corrected {b}_{1 , n} = \frac{{b}_{1 , n - 1} x ( n - 1 ) + {b}_{1 , n}}{n}$$

$$Corrected {c}_{1 , n} = \frac{{c}_{1 , n - 1} \times ( n - 1 ) + {c}_{1 , n}}{n}$$

The approximate curve calculating unit 24 outputs the approximate curve y_{Trans}(x) having the corrected quadratic coefficient a_{1,n}, the corrected linear coefficient b_{1,n}, and the corrected constant term c_{1,n} to the shape estimation processing unit 22 as the corrected approximate curve y_{Trans}(x).

In the third embodiment described above, the road shape estimation device 10 is configured so that the road shape estimating unit 23 calculates the approximate curve representing the point cloud including all the reflection points after translation by the translation unit 19, then corrects the calculated approximate curve using the approximate curve calculated last time, and estimates the shape of the road on which the vehicle travels from the corrected approximate curve. Therefore, similarly to the road shape estimation device 10 according to the first embodiment, the road shape estimation device 10 according to the third embodiment can estimate the shape of the road in some cases even when the number of left reflection points or the number of right reflection points is small, and can stabilize the estimation result of the road shape more than the road shape estimation device 10 according to the first embodiment.

It should be noted that the present disclosure can freely combine the embodiments, modify any component of each embodiment, or omit any component in each embodiment.

### INDUSTRIAL APPLICABILITY

The present disclosure is suitable for a radar signal processing device that estimates the shape of a road, a road shape estimation method, and a road shape estimation program.

### REFERENCE SIGNS LIST

1: signal receiving unit, 2: ADC, 10: road shape estimation device, 11: reflection point detecting unit, 12: Fourier transform unit, 13: peak detecting unit, 14: azimuth detecting unit, 15: reflection point detection processing unit, 16: reflection point classifying unit, 17: group classifying unit, 18: group selecting unit, 19: translation unit, 20: road shape estimating unit, 21: approximate curve calculating unit, 22: shape estimation processing unit, 23: road shape estimating unit, 24: approximate curve calculating unit, 31: reflection point detecting circuit, 32: reflection point classifying circuit, 33: translation circuit, 34: road shape estimating circuit, 35: road shape estimating circuit, 41: memory, 42: processor, 51: vehicle, 52, 53, 54: object

1. A road shape estimation device comprising processing circuitry
to detect, from received signals of a plurality of radio waves reflected by an object present around a vehicle, a plurality of reflection points each indicating a reflection position of each of the radio waves on the object,
to perform classification, among the plurality of reflection points, of reflection points of an object present in an area on a left side with respect to a traveling direction of the vehicle into a first group, and of reflection points of an object present in an area on a right side with respect to the traveling direction of the vehicle into a second group,
to perform translation of each of the reflection points classified into the first group to a right direction of the vehicle orthogonal to the traveling direction of the vehicle, and perform translation of each of the reflection points classified into the second group to a left direction of the vehicle orthogonal to the traveling direction of the vehicle, and
to calculate an approximate curve representing a point cloud including all of the plurality of reflection points after the translation and perform estimation of a shape of a road on which the vehicle travels from the approximate curve.

2. The road shape estimation device according to claim 1, wherein the processing circuitry calculates a first approximate curve representing a point cloud including all reflection points classified into the first group, and translates each of the reflection points classified into the first group by a value of a constant term corresponding to the first approximate curve to a right direction of the vehicle; and
the processing circuitry calculates a second approximate curve representing a point cloud including all reflection points classified into the second group, and translates each of the reflection points classified into the second group by a value corresponding to a constant term in the second approximate curve to a left direction of the vehicle.

3. The road shape estimation device according to claim 2, wherein in the estimation, the processing circuitry performs
to estimate the shape of the road on which the vehicle travels from a third approximate curve represented by a curvature of the approximate curve and the constant term corresponding to the first approximate curve and a fourth approximate curve represented by a curvature of the approximate curve and the constant term corresponding to the second approximate curve.

4. The road shape estimation device according to claim 2, wherein an area around the vehicle is divided into a plurality of divided areas, and, in the classification, the processing circuitry performs:
to specify divided areas among the plurality of divided areas respectively including the plurality of reflection points, and classify, among the specified divided areas, each of a group including a set of divided areas each being in contact with another divided area including any of the plurality of reflection points and a group including only one divided area not in contact with another divided area including any of the plurality of reflection points into a left group present in the area on the left side with respect to the traveling direction of the vehicle or a right group present in the area on the right side with respect to the traveling direction of the vehicle, and
to select, as the first group, a group including the largest number of divided areas among one or more groups classified into the left group, and select, as the second group, a group including the largest number of divided areas among one or more groups classified into the right group.

5. The road shape estimation device according to claim 1, wherein the processing circuitry estimates the shape of the road assuming that a direction of the road at a position where the vehicle is present is parallel to the traveling direction of the vehicle.

6. The road shape estimation device according to claim 1, wherein in the estimation, the processing circuitry performs, after calculating the approximate curve representing the point cloud including all of the plurality of reflection points after the translation, to correct the approximate curve newly calculated using the approximate curve calculated last time, and estimate the shape of the road on which the vehicle travels from the corrected approximate curve.

7. A road shape estimation method, comprising:
detecting, from received signals of a plurality of radio waves reflected by an object present around a vehicle, a plurality of reflection points each indicating a reflection position of each of the radio waves on the object;
classifying, among the plurality of reflection points, reflection points of an object present in an area on a left side with respect to a traveling direction of the vehicle into a first group, and classifying, among the plurality of reflection points, reflection points of an object present in an area on a right side with respect to the traveling direction of the vehicle into a second group;
performing translation of each of the reflection points classified into the first group to a right direction of the vehicle orthogonal to the traveling direction of the vehicle, and performing translation of each of the reflection points classified into the second group to a left direction of the vehicle orthogonal to the traveling direction of the vehicle; and
calculating an approximate curve representing a point cloud including all of the plurality of reflection points after the translation and performing estimation of a shape of a road on which the vehicle travels from the approximate curve.

8. A non-transitory computer-readable medium comprising instructions that, when executed by a processor, cause the processor to perform the method including:
detecting, from received signals of a plurality of radio waves reflected by an object present around a vehicle, a plurality of reflection points each indicating a reflection position of each of the radio waves on the object;
classifying, among the plurality of reflection points, reflection points of an object present in an area on a left side with respect to a traveling direction of the vehicle into a first group, and classifying, among the plurality of reflection points, reflection points of an object present in an area on a right side with respect to the traveling direction of the vehicle into a second group;
performing translation of each of the reflection points classified into the first group to a right direction of the vehicle orthogonal to the traveling direction of the vehicle, and performing translation of each of the reflection points classified into the second group to a left direction of the vehicle orthogonal to the traveling direction of the vehicle; and
calculating an approximate curve representing a point cloud including all of the plurality of reflection points after the translation and performing estimation of a shape of a road on which the vehicle travels from the approximate curve.
